(19) United States
(12) Patent Application Publication
(10) Pub. No.: US 2008/0133532 A1
(43) Pub. Date: Jun. 5, 2008

(54) SYSTEM FOR PROVIDING ENTREPRENEURS AND BUSINESSES ACCESS TO INFORMATION, EDUCATION AND BUSINESS MANAGEMENT TOOLS

(76) Inventors: Howard Keating, Troy, MI (US); Howard Keating, Troy, MI (US); Alan Keating, Troy, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/946,367

(22) Filed: Nov. 28, 2007

Related U.S. Application Data
(60) Provisional application No. 60/868,104, filed on Dec. 1, 2006.

(51) Int. Cl. G06F 17/30; G06F 7/00; G06F 15/16; G06F 12/00

(52) U.S. Cl. 707/9; 707/10; 707/204; 709/204; 707/E17.032; 707/E17.01; 707/E17.001

(57) ABSTRACT

A system and method for providing entrepreneurs and businesses access to information, education and business management tools, and more particularly to such a system operating through the use of a pay-per-view channel and associated Internet site. Users may access all aspects of the system by paying for a membership. Membership privileges allow users to view instructional video concerning relevant aspects of entrepreneurial endeavors, business operations, interact with other like-minded businessmen and experts in various business related fields, as well as advertise and obtain services related to business.

### CROSS REFERENCE TO RELATED APPLICATION

This application claims the benefit of application Ser. No. 60/868,104 filed Dec. 1, 2006.

### BACKGROUND OF THE INVENTION

1. Field of the Invention

This invention relates to a system for providing entrepreneurs and businesses access to information, education and business management tools, and more particularly to such a system operating through the use of a pay-per-view channel and associated Internet site.

2. Description of the Prior Art

Entrepreneurs working toward the creation of a business, and existing businesses, require information relating to a wide range of subjects ranging from various aspects of finance, marketing, business organization, insurance, legal affairs, etc. While this information is available from a wide variety of sources, each dealing with one of the topics, entrepreneurs and business managers typically lack the time to seek pertinent information relating to each topic of relevance to their business from a difference source. It would clearly be desirable to provide a single information source which deals with all of the wide-ranging problems encountered by entrepreneurs or people involved in business ventures. It would further be desirable to provide this information in a form that is convenient to use and is presented in an interesting manner to maintain the attention of users. It would additionally be desirable to provide such an information source that first provides the information in a general manner and then provides a mechanism for allowing a member to obtain more detailed information regarding the subject.

### SUMMARY OF THE INVENTION AND ADVANTAGES

The invention broadly comprises a system and method of providing information, education and business management tools of interest to entrepreneurs and persons operating a business, comprising providing a pay-per-view television channel that broadcasts a daily schedule of programming dealing with various aspects of starting up and operating businesses, and to an associated Internet website which provides more detailed information on the topics covered in the television programming, and the opportunity to engage in interactive dialogs with experts relating to these business topics.

In one embodiment of the invention, after a person with expertise in a particular subject has appeared on a program on the cable channel dealing with a matter of interest to the users, a user may present detailed questions to the lecturer via the Internet, using a proprietary website. In a preferred embodiment of the invention, a subscription to the website provides a method with a password that may be employed to access the Internet site. Alternatively, the Internet site may be freely available to all parties on the Internet, but a password is required to access certain sections or to pose questions directly to experts. By way of example, the topic of a program on the cable channel may be “health insurance for small businesses”. A party viewing this presentation may have questions arising from the unique nature of his business enterprise which were not covered during the cable presentation and, using the password received as part of the subscription to the cable channel, may access the internet site operated by the proprietors of the system of the present invention and may pose more detailed questions to either the expert who lectured on the cable channel or other specialists in small business health insurance. In this way a business subject may be covered in a general manner, of interest to all participants, on the cable channel with detailed aspects of the matter handled through personal interactive communications via the Internet site.

The cable channel presentation is preferably accompanied by a moving crawl containing information relating to specific contacts that may be useful to viewers. For example, the crawl may include information relating to job opportunities, information relating to persons seeking jobs, contracts that are up for bid, offers of business equipment, and the like. Typically the crawl contents would be archived on the associated website along with more detailed information relating to the offerings such as the detailed nature of a contract on which bids are requested, the resume of a job seeker, etc.

A variety of other services useful to the viewers could be provided, such as offerings of credit guaranties on sales by the members, special health insurance offerings to the members, and the like. Broadly, the system of the present invention can provide information and education that is pertinent to the user's business activity, as well as links which foster communication between the viewers and a wide variety of potential customers, vendors, services, and the like. The website could provide online training with a wide variety of business-oriented programs, and additionally could provide online learning from universities which offer certificates, degrees and college credit. The website could offer online trade shows, allowing the viewers the ability to view and participate in trade shows without the time and expense of traveling to those shows.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic of the system.

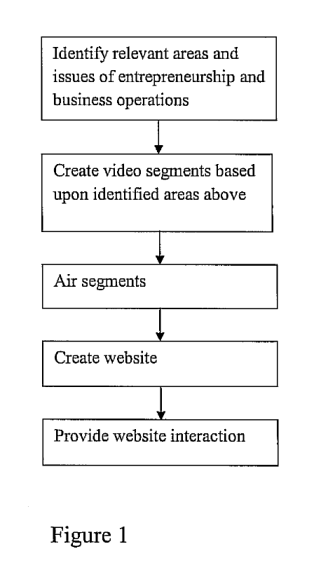

FIG. 2 is a block diagram showing the method for providing information to a member.

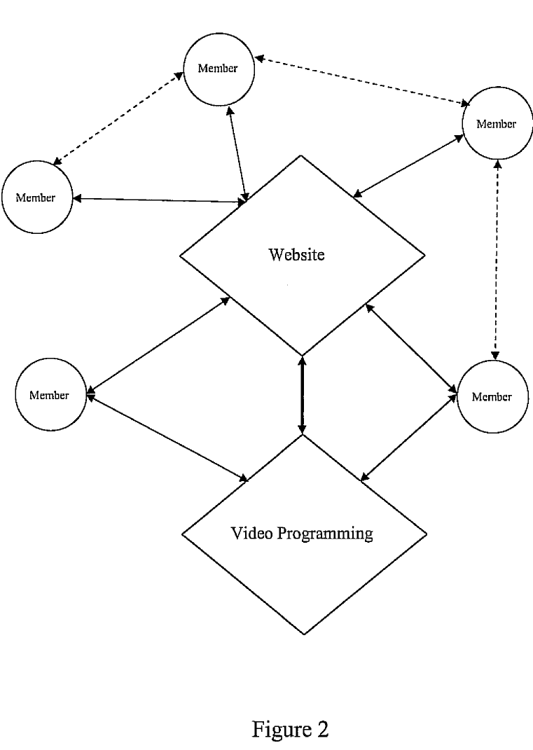

### DETAILED DESCRIPTION OF THE INVENTION

A system 20 and method 22 for providing entrepreneurs and businesses with information, education, and business management tools, the system 20 and method 22 having a video program 24, a network, an interactive website 26, and a member interface 28. The video program 24 is run continuously and aired through the network. The network can be either satellite or cable television channel.

The video program 24 is further defined by a series of segments 30. Each segment 30 is tailored to instruct a member on a particular area of business, such as business formations, changing regulations, opportunities for tax breaks, and the like. Accordingly, it is crucial that areas of concern among businesses and entrepreneurs are identified, and that the business climate is constantly assessed in order for the programming to be relevant. The length of the segment 30 will vary according to the information desired to be disseminated. For instance, a segment 30 concerning the formation of offshore tax shelters may be longer in duration than a segment 30 on inventory control. The segment 30 can be in a lecture form, where an expert in a particular field is given the opportunity to instruct on a topic, or the segment 30 can be in the form of a news show where relevant business stories are reported to viewers. The video programming can have commercials and other forms of advertisement injected therein. The commercials can be a video program 24 aired either within a running segment 30, or between segments 30. Commercials can also assume other forms such as a crawl script 32 rolling across the screen for the viewers to observe while watching the video program 24. The crawl script 32 can provide advertisements for goods or services, or news breaking updates.

The video programming may be accessed by members. The system 20 provides different levels of membership. Each member is given a password 34 and a level of access depending upon the membership package chosen. The member information is then stored in a membership database. The membership database is only accessible by the administrators of the present invention and will allow members to retrieve their information in order to gain access to their privileges. The privileges granted by membership will also determine the amount of access each member has with respect to the website 26. In order to access the website 26, a member must log on to the website's 26 homepage using their member identification and password 34.

The website 26 has a plurality of webpages. Some of the webpages may be available to any user, while others are only accessible to paying members. One page may serve as a news page where users and members may peruse through and read articles of interest. Another webpage may provide only members with an opportunity to interact with certain segments 30 as the segments 30 are being aired. For example, a member watching a lecture may log on to the website 26 and navigate towards a page that is associated with the current running segment 30. Once at the webpage, the member may pose questions directly to the lecturer by either typing the questions onto the webpage, speak directly to the lecturer via a video conferencing or speaker device, or obtain more detailed information concerning the segment. Another webpage may host a forum, such as a chat room, for discussing a particular issue. These chat rooms may be hosted by an expert in a certain field thus allowing members to have direct communication with an expert regarding issues the member may not be familiar with. Yet another webpage may be dedicated to advertisements whereby users may offer their goods or services, or select among the goods or services offered.

Furthermore, the webpage will contain hyperlinks 36 users and members may click on in order to access other webpages. Some of these hyperlinks 36 are freely accessed and placed on the website 26 by the website 26 administrators, while other hyperlinks 36 are only inserted by a paying member. The each webpage will have a crawl script 32; the crawl script 32 may also contain hyperlinks 36 to further information so that information of interest to a member or users contained therein may be instantly accessed. Broadly, the website 26 offers numerous opportunities for members to interact not only with the video programming, but with the other members and captains of industry as well. Such opportunities include but are not limited to on-line training programs, college degrees from universities, certification in various fields of business and industry, on-line trade shows, assistance with government regulations, insurance planning, and multi-level direct sales opportunities.

The video segments 30, crawl scripts 32, and other information contained on the website 26 and in the video programming are stored in an archive database 38, the archive database 38 being in communication with a webpage of the website 26. Accordingly, members may be able to access segments 30 that they were not able to observe the first time, as well as other information which were temporarily displayed such as the crawl scripts 32.

Obviously many modifications and variations of the present invention are possible in light of the above teachings and may be practiced otherwise than as specifically described while within the scope of.

What is claimed is:

1. A system for providing business establishment and operation related information to members, comprising:
a video program provided over a network, the video program comprising a plurality of segments related to business creation and operation, business opportunities, services available to business, and the like;
a website including proprietary business formation and operation information on a more detailed level than the network, the website being in communication with the network; and
a member interface, the interface allows viewers to interact with the video program and the website.

2. A system for providing business establishment and operation related information to members, as set forth in claim 1 wherein the website also having a plurality of forums, such as a chat room, for member interaction.

3. A system for providing business establishment and operation related information to members, as set forth in claim 2 further comprising an archive database for storing information, the archive database being in communication with the website and accessible by the member via the interface.

4. A system for providing business establishment and operation related information to members, as set forth in claim 1 wherein the interface allows data to be communicated to the website, such as a keyboard.

5. A system for providing business establishment and operation related information to members, as set forth in claim 1 wherein the segments have at least one crawl script, the crawl script airing concurrently with segment and having information relating to advertisement or news.

6. A system for providing business establishment and operation related information to members, comprising:
a video program provided over a network, the video program comprising a plurality of segments related to business creation and operation, business opportunities, services available to business, and the like;
a website including proprietary business formation and operation information on a more detailed level than the cable channel, the website being in communication wilt the cable channel, and website also having alternative venues for member interaction such as a chat room;
an archive database system for storing information, the archive database being in communication with the website and accessible by the member via the interface; and
a member interface, the interface allows viewers to interact with the video program.

7. A method for providing business establishment and operation related information to members, comprising:
identifying information that may be of interest to entrepreneurs who desire to establish a business, the information being constantly updated to reflect changing business climates and regulations;
creating a video program through a cable and internet system, the video program including segments having the information, and being run continuously;
airing the video program through a channel; the channel being supported by either a cable or satellite network;
creating a website, the website having further detail pertaining to the video programming; and
providing a member interface, the member interface being achieved through an internet connection with both the website and the channel, the member interface allowing members access to the video program and the website.

8. A method for providing business establishment and operation related information to members, as set forth in claim 5 further comprising assigning privileges to viewers and members, the privileges determine the amount of access the viewers and members have.

9. A method for providing business establishment and operation related information to members, as set forth in claim 5 further comprising assigning a password, the password availing to its respective member the privileges paid for by the member.

10. A method for providing business establishment and operation related information to members, as set forth in claim 5 further comprising creating a plurality of forums such as chat rooms for interaction, the forums being separate from the video program.

11. A method for providing business establishment and operation related information to members, comprising:
identifying information that may be of interest to entrepreneurs who desire to establish a business, the information being constantly updated to reflect changing business climate and regulations;
creating a video program through a cable and internet system, the video program including segments having the information, and being run continuously;
airing the video program through a channel; the channel being supported by either a cable or satellite network,
assigning privileges to viewers and members, the privileges determine the amount of access the viewers and members have;
creating a website, the website being in communication with the video program, the website providing more detailed information pertaining to the video program;
creating alternate venues for interaction, the venues being separate from the video program such as a chat room; and
providing a member interface, the member interface being achieved through an integrated internet connection with the channel, the member interface being password protected and allowing members access to the video program based upon the member's privilege.
